(19) United States
(12) Patent Application Publication
(10) Pub. No.: US 2006/0083461 A1
(43) Pub. Date: Apr. 20, 2006

(54) Multimode wavelength multiplexing optical transceiver

(75) Inventors: Ryuta Takahashi, Hitachi (JP); Koki Hirano, Hitachinaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 11/295,456

(22) Filed: Dec. 7, 2005

(30) Foreign Application Priority Data
Jan. 21, 2004 (JP) 2005-013924

(51) Int. Cl. G02B 6/26; G02B 6/28

(52) U.S. Cl. 385/28; 385/24

(57) ABSTRACT

A multimode wavelength multiplexing optical transceiver has: a plurality of light emitting elements that emit single-mode lights with wavelengths different from each other; and a multimode waveguide module that is operable to multiplex the emitted single-mode lights into a multimode light. The multimode waveguide module is a step-index type multimode waveguide module that is operable to reduce a low-order mode component of the multimode light.

The present application is based on Japanese patent application No. 2005-013924, the entire contents of which are incorporated herein by reference.

### BACKGROUND OF THE INVENTION

1. Field of the Invention

This invention relates to a multimode wavelength multiplexing optical transceiver that MMF can be used as a transmission line and, particularly, to a multimode wavelength multiplexing optical transceiver that can reduce a low-order mode component without using any mode conditioning path cord.

2. Description of the Related Art

In general, in a wavelength multiplexing optical transceiver for transmitting/receiving a wavelength-multiplexed light, a single-mode optical fiber (SMF) is connected to its transmit-side output terminal and an SMF or a multimode optical fiber (MMF) is connected to its receive-side input terminal. The reason to connect the SMF to the transmit-side output terminal is that a single-mode light is output from the transmit-side output terminal. When the MMF is used as a transmission line, a mode-conditioning patch cord is needed to be provided between the MMF transmission line and the transmit-side output terminal.

The mode-conditioning patch cord is used to reduce a low-order mode component to be generated when a single-mode light from the SMF is introduced into the MMF. The reason to reduce the low-order mode component is that, when the other wavelength multiplexing optical transceiver receives a multimode light through the MMF transmission line, a differential mode delay is caused by the low-order mode component, thereby increasing a bit error rate when a digital signal carried on the light is decoded.

FIG. 4 shows a connection between a conventional wavelength multiplexing optical transceiver and a transmission line.

As shown, a mode-conditioning patch cord 46 is connected to a transmit-side output terminal 42 of the wavelength multiplexing optical transceiver 41. An MMF transmission line 43 is connected through a connector 47 to the mode-conditioning patch cord 46. In this example, an MMF transmission line 45, which may be replaced by an SMF, is connected to a receive-side input terminal 44.

The related art of the invention is, for example, JP-A-2003-014994.

As described earlier, when a GIF (MMF) is used as the transmission line, the mode-conditioning patch cord is needed to be connected to the transmit-side output terminal. This troubles a worker to connect the mode-conditioning patch cord, necessitates securing the mode-conditioning patch cord or a connector thereof by some member, and affects its transmission loss due to an increase in optical connection part. Namely, the mode-conditioning patch cord for reducing the low-order mode component causes the other problems.

Next, the differential mode delay due to the low-order mode component will be explained in detail.

A light-emitting element in the wavelength multiplexing optical transceiver outputs a single-mode light. It is assumed that a graded type multimode optical fiber (GIF) is used as a transmission line. An ideal refractive index profile at a core section of the GIF is, as shown in FIG. 5A, to be a quadratic curve with a center axis at the center position of the core. However, an actual refractive index profile at a core section of the GIF is, as shown in FIG. 5B or 5C, a quadratic curve with a partial deformation such as a convex or concave. This deformation is called a deviation in refractive index (or refractive index profile)

When a single-mode light is inputted to the GIF with the refractive index profile that the refractive index at the center of the core is, as shown in FIG. 5B, deviated to be higher than the ideal characteristic, a low-order mode light to pass in the vicinity of the center of the GIF core propagates at speed slower than a high-order mode light to pass at the periphery of the core away from the center of the core since the refractive index in the vicinity of the center of the core is higher than the ideal characteristic as shown in FIG. 5A. Thus, since the propagation speed differentiates between the low-order mode and the high-order mode of the wavelength-multiplexed light, the bit error rate increases when a digital signal carried on the wavelength-multiplexed light is decoded.

In contrast, when the single-mode light is inputted to the GIF with the refractive index profile that the refractive index at the center of the core is, as shown in FIG. 5C, deviated to be lower than the ideal characteristic, the low-order mode light to pass in the vicinity of the center of the GIF core propagates at speed higher than the high-order mode light to pass at the periphery of the core away from the center of the core since the refractive index in the vicinity of the center of the core is lower than the ideal characteristic as shown in FIG. 5A.

The variation of signal waveform due to the difference in propagation speed between the modes will be explained below.

It is assumed that an optical signal inputted to the GIF is such that, as shown in FIG. 6A, its optical energy monotonously increases with time, and then monotonously decreases from a maximum value. If the core is provided with the ideal refractive index profile as shown in FIG. 5A, an optical signal outputted from the GIF is such that, as shown in FIG. 6B, the optical energy monotonously increases with time, and then monotonously decreases from the maximum value. Namely, the signal waveform is not varied.

If the refractive index profile is deviated as shown in FIG. 5B or 5C, when an optical signal as shown in FIG. 6C, which is the same as in FIG. 6A, is inputted to the GIF, optical energy of the low-order mode propagates being deviated in time from optical energy of the high-order mode. Therefore, the optical signal outputted from the GIF has, as shown in FIG. 6D, two maximum values, and a time width from the start of increase to the end of decrease in optical energy is elongated. This variation in signal waveform will cause an increase in bit error rate.

As described above, the mode-conditioning patch cord as shown in FIG. 4 is used in the conventional technology since the increase in bit error rate is caused by the variation of signal waveform in the transmission line using the GIF.

### SUMMARY OF THE INVENTION

It is an object of the invention to provide a multimode wavelength multiplexing optical transceiver that can reduce the low-order mode component without using the mode conditioning path cord.

According to one aspect of the invention, a multimode wavelength multiplexing optical transceiver comprises:

a plurality of light emitting elements that emit single-mode lights with wavelengths different from each other; and

a multimode waveguide module that is operable to multiplex the emitted single-mode lights into a multimode light, wherein the multimode waveguide module comprises a step-index type multimode waveguide module that is operable to reduce a low-order mode component of the multimode light.

In the above invention, the following modifications or changes can be made.

(i) The optical transceiver further comprises a receptacle that connects an external member to transmit the multimode light emitted from the multimode waveguide module.

(ii) The multimode waveguide module comprises a core bending portion that is operable to generate a high-order mode component of the multimode light.

(iii) The multimode waveguide module comprises a core tapered portion that is operable to generate a high-order mode component of the multimode light.

(iv) The multimode waveguide module comprises an input side core to guide light from each of the light emitting elements, a core coupling section to multiplex the guided lights into a wavelength-multiplexed light, and an output side core to guide the wavelength-multiplexed light to an optical fiber receptacle.

(v) The optical transceiver further comprises a package with a lens in which the light emitting element is sealed, wherein the package is attached to an end face of the waveguide module.

According to another aspect of the invention, a multimode wavelength multiplexing optical transceiver comprises:

a plurality of light emitting elements that emit single-mode lights with wavelengths different from each other;

an optical fiber coupler that is operable to multiplex the emitted single-mode lights; and

a multimode waveguide module that is operable to convert the multiplexed single-mode light into a multimode light, wherein the multimode waveguide module comprises a step-index type multimode waveguide module that is operable to reduce a low-order mode component of the multimode light.

In the above invention, the following modifications or changes can be made.

(vi) The optical transceiver further comprises a package with a single-mode optical fiber in which the light emitting element is placed, wherein the optical fiber of the package is connected to the optical fiber coupler.

### BRIEF DESCRIPTION OF THE DRAWINGS

The preferred embodiments according to the invention will be explained below referring to the drawings, wherein:

FIG. 1 is a schematic diagram showing a multimode wavelength multiplexing optical transceiver in a preferred embodiment according to the invention;

FIG. 2 is a schematic diagram showing a connection between the multimode wavelength multiplexing optical transceiver of the embodiment and transmission lines;

FIG. 3 is a schematic diagram showing a multimode wavelength multiplexing optical transceiver in another preferred embodiment according to the invention;

FIG. 4 is a schematic diagram showing the conventional transceiver and the transmission line;

FIGS. 5A to 5C are diagrams showing a refractive index profile in the core diameter direction of a transmission line, where FIG. 5A shows an ideal profile, and FIGS. 5B and 5C show a variation in the profile;

FIGS. 6A to 6D are diagrams showing a time waveform to be inputted/outputted to or from the transmission line, where FIG. 6A shows an input waveform, FIG. 6B shows an ideal output waveform, FIG. 6C shows the same input waveform as FIG. 6A, and FIG. 6D shows a varied output waveform; and

FIG. 7 is a plain view showing a waveguide module used in a preferred embodiment of the invention.

### DETAILED DESCRIPTION OF THE PREFERRED EMBODIMENTS

The invention is featured in that a step-index type multimode waveguide module is used in a multimode wavelength multiplexing optical transceiver that single-mode lights outputted from plural light emitting elements are multiplexed into a multimode light. When the single-mode lights are converted into the multimode light by the step-index type multimode waveguide module, the low-order mode (e.g., primary basic mode at the minimum) component decreases and the high-order mode (modes other than the basic mode) increases instead. The multiplexing of the single-mode lights can be conducted by using the step-index type multimode waveguide module or an optical fiber coupler.

Thus, the low-order mode component which is subject to the change of propagation speed due to the refractive index profile of GIF as described earlier decreases, and the high-order mode component which is not subject to the change of propagation speed due to the refractive index profile of GIF increases. Therefore, as a whole, it becomes less likely to be subject to the change of propagation speed due to the refractive index profile of GIF.

In the following preferred embodiments, the multiplexing of single-mode lights are conducted by using the step-index type multimode waveguide module or an optical fiber coupler.

### First Embodiment

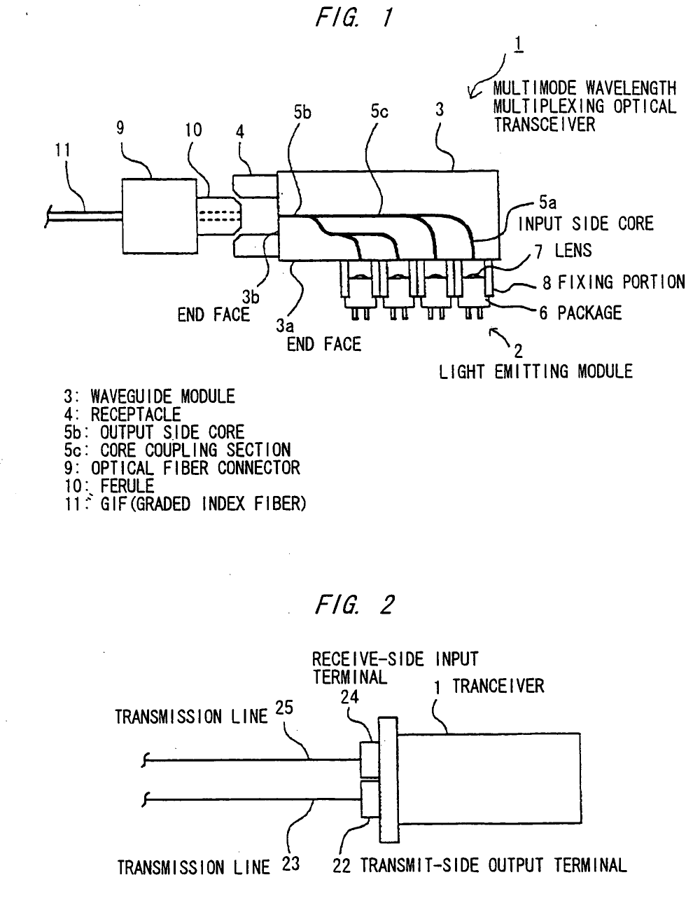

FIG. 1 is a schematic diagram showing a multimode wavelength multiplexing optical transceiver in the first preferred embodiment according to the invention.

As shown, the multimode wavelength multiplexing optical transceiver (hereinafter simply called transceiver) 1 comprises: plural light emitting modules 2 that light emitting elements to output single-mode lights with wavelengths different each other is sealed in a package with a lens; the step-index type multimode waveguide module 3 that guides and multiplexes lights from the light emitting modules and allows the reduction of the low-order mode component in generating a multimode light; and an optical fiber connector receptacle (hereinafter simply called receptacle) 4 that is provided at an output terminal for outputting the multiplexed multimode light from the step-index type multimode waveguide module 3.

The transceiver 1 is provided with a component for reception, but the component is omitted herein. Further, the transceiver 1 is provided with a component for driving the light emitting element of the light emitting module based on a transmitted digital signal, but the component is omitted herein.

The waveguide module 3 is formed as a rectangular solid in which a core and a clad are laminated on a base material. In general, the entire rectangular solid is called a waveguide. However, the core is substantially the waveguide. In order to avoid the confusion in terminology, the entire rectangular solid is herein called a waveguide module.

The waveguide module 3 comprises plural input side cores 5a that are disposed at appropriate intervals on an end face 3a where the light emitting modules 2 are arrayed; a output side core 5b that is disposed on an end face 3b to which the receptacle 4 is attached; and a core coupling section 5c that the input side cores 5a are bent with a suitable bending radius such that the input side cores 5a to be accessed 5b from a direction nearly orthogonal to the output side core 5b is merged at an angle of nearly zero degree with the output side core 5b. The merging angle is desirably 2 degrees or less to reduce the transmission loss, and desirably 0.5 degrees or more to facilitate the manufacture and to enhance the yield. In this embodiment, it is set to be 0.7 degrees based on the above considerations. The input side core 5a serves to guide a light from each light emitting module 2 to the core coupling section 5c. The core coupling section 5c serves to multiplex the lights from the input side core 5a. The output side core 5b serves to guide the multiplexed light to an end (output terminal) of the output side core 5b which is located at the end face 3b and in the receptacle 4. These cores 5a, 5b and 5c are operable to guide a multimode light and has a core diameter of 25 μm square.

The light emitting module 2 has a lens 7 attached to the head portion of a package 6 formed as a cylindrical column or rectangular column. The light emitting module 2 is attached to a fixing portion 8 provided perpendicularly projecting from the end face 3a of the waveguide module 3, and the lens 7 is faced to the end face of the input side core 5a.

The receptacle 4 is a cylindrical member provided perpendicularly projecting from the end face 3b of the waveguide module 3, and a ferule 10 of an optical fiber connector 9 can be inserted thereinto. The optical fiber connector 9 is attached to the end of GIF 11 to compose the transmission line. The GIF 11 is inserted to the center of the ferule 10. When the ferule 10 of the optical fiber connector 9 is inserted into the receptacle 4, the GIF 11 can be optically coupled to the output side core 5b of the waveguide module 3. The receptacle 4 is secured to a member (not shown) to fix the waveguide module 3.

FIG. 2 is a schematic diagram showing a connection between the multimode wavelength multiplexing optical transceiver of the embodiment and transmission lines.

As shown, a transmission line 23 of GIF is connected to a transmit-side output terminal 22 of the transceiver 1. The transmit-side output terminal 22 is nothing but the receptacle 4 in FIG. 1. A transmission line 25 of GIF is connected to a receive-side input terminal 24.

The functions and effects of the first embodiment will be described below.

In the transceiver 1 as shown in FIG. 1, single-mode lights with different wavelengths emitted from each light emitting module 2 is inputted to each input side core 5a of the waveguide module 3. The lights guided through the input side cores 5a are sequentially multiplexed at the core coupling section 5c, and then guided, as multiplexed light, to the output side core 5b, and outputted to the GIF 11 in the ferule 10. In this process, since the cores 5a, 5b and 5c of the waveguide module 3 are operable to guide multimode light, the single-mode light is changed into multimode light. In this case, since the waveguide module 3 is of step-index type and the waveguide module 3 has a Y-branch inside thereof, a low-order mode component generated in the multimode light is attenuated to about ⅙. Thus, the wavelength-multiplexed light outputted from the output side core 5b to the MMF 11 is a multimode light with the reduced low-order mode component.

In FIG. 2, light to be inputted to the transmission line 23 of GIF from the transmit-side output terminal 22 of the transceiver 1 is the multimode light with the reduced low-order mode component. Therefore, when the other transceiver (not shown) receives this light and a digital signal carried on the light is reproduced, an increase in bit error rate due to the low-order mode component is not observed.

As described above, in this embodiment, an extraneous member such as a mode-conditioning patch cord need not be connected to the transmit-side output terminal. Therefore, the connection work can be simplified, the number of components can be reduced, and transmission loss in the transmission line can be reduced.

### Second Embodiment

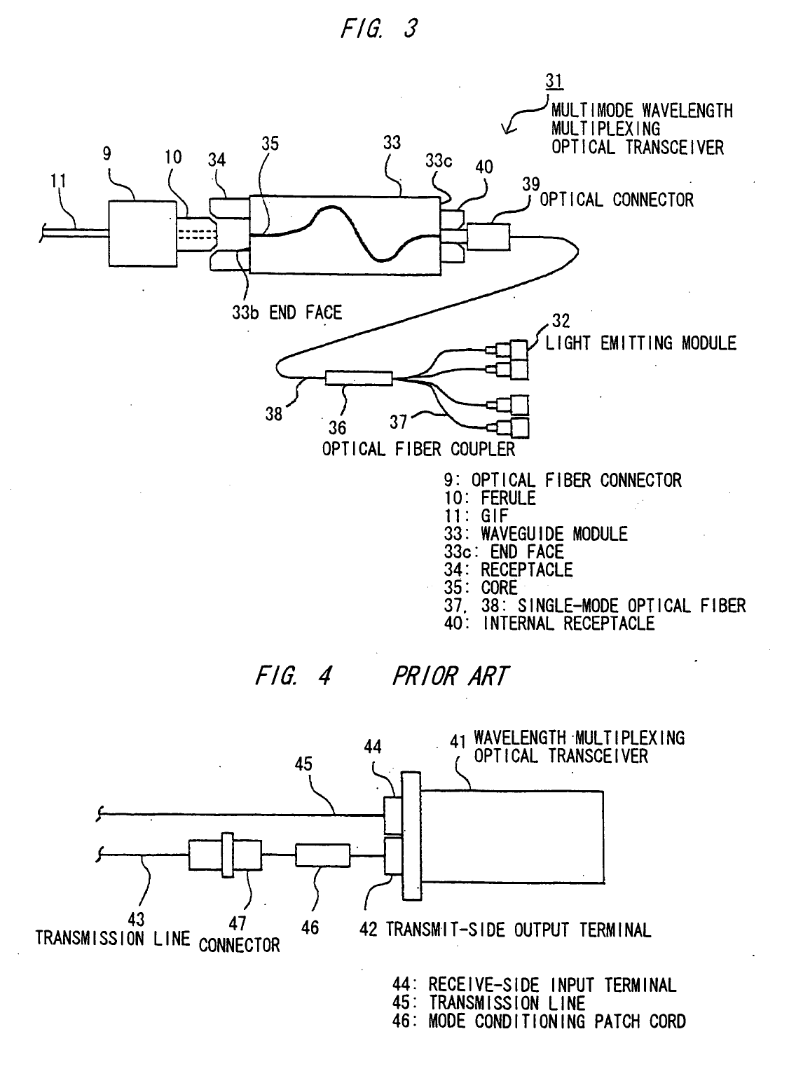

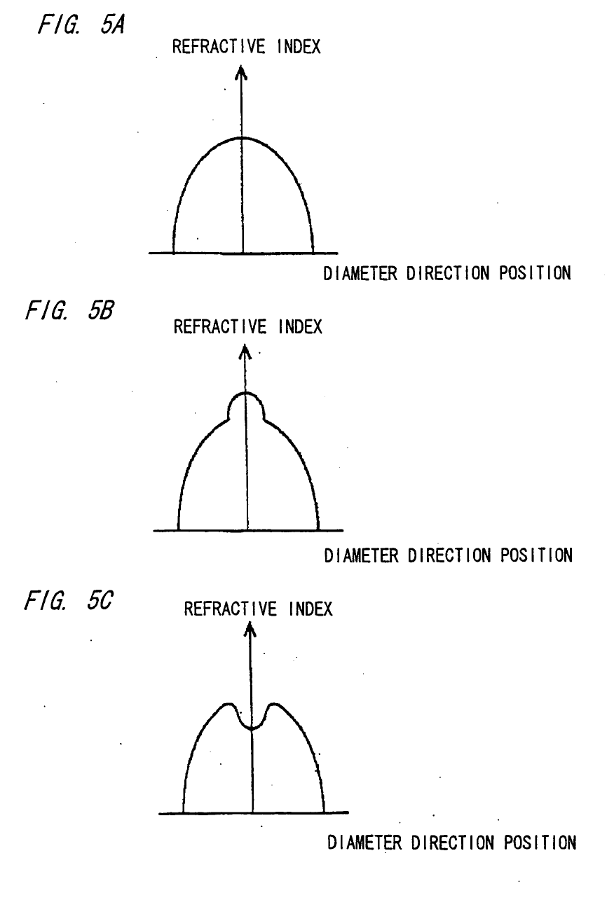

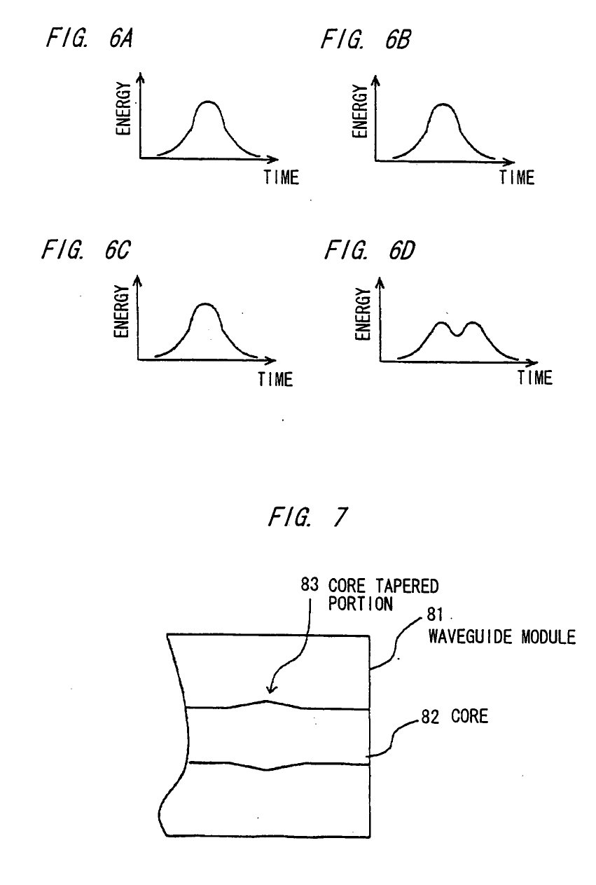

FIG. 3 is a schematic diagram showing a multimode wavelength multiplexing optical transceiver in the second preferred embodiment according to the invention.

As shown, the multimode wavelength multiplexing optical transceiver (hereinafter simply called transceiver) 31 comprises: plural light emitting modules 2 that light emitting elements to output single-mode lights with wavelengths different each other is sealed in a package with an optical fiber; a single-mode optical fiber coupler (hereinafter simply called optical fiber coupler) 36 to multiplex lights from the light emitting modules 2; a waveguide module 33 that has a core 35 with a core diameter of 25 μm square, guides and multiplexes lights from the light emitting modules, and allows the reduction of the low-order mode component in generating a multimode light; and a receptacle 4 that outputs the multiplexed multimode light from the waveguide module 33.

The light emitting module 32 is of so-called a pig tale type, and is provided with a single-mode optical fiber 37 an optical axis of which is previously aligned with an internal light emitting element. The optical fibers 37 are connected to the optical fiber coupler 36. A single-mode optical fiber 38 is also connected to the output side of the optical fiber coupler 36. An optical connector 39 is connected to the end of the single-mode optical fiber 38.

An internal receptacle 40 to connect the optical connector 39 is provided at an end face 33c of the waveguide module 33. A receptacle 34 for external connection is provided at an end face 33b opposite to the end face 33c.

The optical fiber connector 9, the ferule 10 and the GIF 11 are the same as in FIG. 1.

In this embodiment, single-mode lights with different wavelengths emitted from the light emitting module 32 are multiplexed into wavelength-multiplexed light by the optical fiber coupler 36, and then inputted to the core 35 of the waveguide module 33. Since the core 35 of the waveguide module 33 is operable to guide multimode light, the single-mode light is changed into multimode light. In this case, since the waveguide module 33 is of step-index type and the waveguide module 33 has a Y-branch inside thereof, a low-order mode component generated in the multimode light is attenuated to about 1/10. Thus, the wavelength-multiplexed light outputted from the core 35 to the GIF 11 is a multimode light with the reduced low-order mode component.

The connection between the transceiver 31 and the transmission line is as shown in FIG. 2. The functions and effects of this embodiment is the same as the first embodiment. When the other transceiver (not shown) receives this light and a digital signal carried on the light is reproduced, an increase in bit error rate due to the low-order mode component is not observed.

The details of the waveguide module will be described below.

The step-index type multimode waveguide module can be developed by forming, as a part of the core, any one of a core bending portion, a core deviation portion and a core tapered portion.

The waveguide module 3 of the transceiver 1 in FIG. 1 comprises a flat plate type optical waveguide element that the cores 5a, 5b and 5c and the clad (not shown) are formed on the base material. The waveguide module 3 has a core bending portion (not indicated with numeral) provided on the way from the input side core 5a through the core coupling section 5c to the output side core 5b.

The waveguide module 33 of the transceiver 31 in FIG. 3 comprises a flat plate type optical waveguide element that the core 35 and the clad (not shown) are formed on the base material. The waveguide module 33 has plural core bending portions (not indicated with numeral) formed by bending the core 35 with a bending radius as described below.

The bending radius of the bending portions is desired to be small so as to minimize the waveguide module 33, but, when it is too small, the high-order mode component is attenuated to increase the propagation loss. Therefore, the bending radius in the embodiment is set to be 2 to 4 mm such that the transmission loss of the high-order mode is negligible. The waveguide module 33 has a difference Δ in specific refractive index of 3.2%. The bending radius can be determined according to the difference Δ in specific refractive index.

A waveguide module 81 as shown in FIG. 7 has a core tapered portion 83 that a core 82 is expanded in the width direction at a part in the longitudinal direction of the core 82 extending linearly. Due to the core tapered portion 83, a high-order mode component in multimode light can be generated. The core tapered portion 83 can be formed with an area smaller than the core bending portion as shown in FIG. 3. As a result, the waveguide module 81 can be downsized relatively.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A multimode wavelength multiplexing optical transceiver, comprising:
a plurality of light emitting elements that emit single-mode lights with wavelengths different from each other; and
a multimode waveguide module that is operable to multiplex the emitted single-mode lights into a multimode light,
wherein the multimode waveguide module comprises a step-index type multimode waveguide module that is operable to reduce a low-order mode component of the multimode light.

2. The multimode wavelength multiplexing optical transceiver according to claim 1, further comprising:
a receptacle that connects an external member to transmit the multimode light emitted from the multimode waveguide module.

3. The multimode wavelength multiplexing optical transceiver according to claim 1, wherein:
the multimode waveguide module comprises a core bending portion that is operable to generate a high-order mode component of the multimode light.

4. The multimode wavelength multiplexing optical transceiver according to claim 1, wherein:
the multimode waveguide module comprises a core tapered portion that is operable to generate a high-order mode component of the multimode light.

5. The multimode wavelength multiplexing optical transceiver according to claim 1, wherein:
the multimode waveguide module comprises an input side core to guide light from each of the light emitting elements, a core coupling section to multiplex the guided lights into a wavelength-multiplexed light, and an output side core to guide the wavelength-multiplexed light to an optical fiber receptacle.

6. The multimode wavelength multiplexing optical transceiver according to claim 1, further comprising:
a package with a lens in which the light emitting element is sealed,
wherein the package is attached to an end face of the waveguide module.

7. A multimode wavelength multiplexing optical transceiver, comprising:
a plurality of light emitting elements that emit single-mode lights with wavelengths different from each other;
an optical fiber coupler that is operable to multiplex the emitted single-mode lights; and
a multimode waveguide module that is operable to convert the multiplexed single-mode light into a multimode light,
wherein the multimode waveguide module comprises a step-index type multimode waveguide module that is operable to reduce a low-order mode component of the multimode light.

8. The multimode wavelength multiplexing optical transceiver according to claim 7, further comprising:
a package with a single-mode optical fiber in which the light emitting element is placed,
wherein the optical fiber of the package is connected to the optical fiber coupler.
